(19) United States
(12) Patent Application Publication
(10) Pub. No.: US 2009/0173051 A1
(43) Pub. Date: Jul. 9, 2009

(54) SHREDDER DEVICE, IN PARTICULAR FOR AGRICULTURAL MACHINES

(76) Inventor: Enrico Aurora, Miglianico (IT)

Correspondence Address: ECKERT SEAMANS CHERIN & MELLOTT, 600 GRANT STREET, 44TH FLOOR, PITTSBURGH, PA, 15219, US

(21) Appl. No.: 12/301,259

(22) PCT Filed: May 16, 2007
(86) PCT No.: PCT/EP07/54771

§ 371 Date: Nov. 18, 2008

(30) Foreign Application Priority Data
May 18, 2006 (IT) RM2006A000268

(51) Int. Cl. A01D 34/43; A01D 34/53; A01D 34/00

(52) U.S. Cl. 56/14.7; 56/249

(57) ABSTRACT

A shredder device, in particular for agricultural machines, comprises a bearing structure, able to be stably associated with a drive machine and defining, in cooperation with the ground, a cutting chamber, at least a rotor rotatable around an axis of rotation, assembled on said bearing structure and housed inside said cutting chamber, a plurality of blades, supported on said at least one rotor and extending away from the axis of rotation of said rotor to intercept and shred material deposited on the ground. Each of said blades is rigidly constrained and in a stable position on said rotor. The shredding action is improved thanks to the use of counter-blades, assembled in a fixed position on said bearing structure and each one operatively associated with a respective blade so as to generate a scissor-like shredding action on the material to be shredded.

The present invention concerns a shredder device, in particular for agricultural machines.

The invention is applied in the field of agricultural machines used for shredding and cutting up vegetable products such as grass, cornstalks, vine shoots or pruning residues and, more particularly, in the field of non-self-propelled devices applicable to tractors or other agricultural machines.

This type of agricultural machines differ from other agricultural machines used for working the ground (such as for example milling machines, diggers, harrows) in that, unlike the latter, they do not come into direct contact with the ground, but cut and shred everything that is deposited on the ground, leaving the ground itself intact.

As is known, tractors and other agricultural machines are equipped, generally in the rear part, with attachment elements able to support interchangeable devices for performing various functions. For example, first a digger, then a harrow and finally a sowing device can be attached to a single tractor.

These attachment elements generally also comprise motion transmission means, for example a universal joint, to transmit mechanically to the device a part of the power developed by the tractor and necessary to move the device.

With particular reference to shredder machines, shredder devices able to be associated with agricultural machines or tractors are generally known, comprising an external bearing casing, rigidly connected to the tractor, and supporting a rotary shaft equipped with articulated tools. The articulated tools are disposed on an external surface of the rotary shaft, generally organized in rows parallel to the axis of rotation of the rotary shaft, and are intended for shredding material present on the ground.

Moreover, the articulated tools extend from the rotary shaft and are rotatable with respect to an external surface of the shaft, for example by means of hinges. In particular the tools are movable between an inactive position, in which they assume a position determined by the force of gravity acting on them and by their angular position on the rotary shaft, and an operating position, in which they are disposed in a position substantially radial with respect to the rotary shaft, determined by centrifugal forces acting on the tools.

Each tool has pointed ends to cut the material present on the ground.

The external casing of known devices, moreover, surrounds the rotary shaft and the tools above and at the sides, so as to delimit internally a respective cutting chamber protecting possible operators who may be found in the immediate vicinity from impacts with parts of cut material arriving from the cutting chamber.

The external casing can generally be equipped internally with deflector plates, welded onto the casing, which perform the function of guiding the material in motion inside the cutting chamber, and supply a further aid to shredding the material following impacts with the deflector plates themselves.

Known shredder devices have various disadvantages, however.

First of all, it must be considered that the operating position kept by the tools is determined only by the centrifugal force acting on them. When there is an excess of material inside the cutting chamber, the tools tend to bend back, rotating around the respective hinge, reducing or even canceling the shredding of the material and therefore limiting themselves to a simple action of drawing the material inside the cutting chamber. Moreover, shredder devices of the type just described need to generate a rotation of the rotary shaft at high speed, in order to produce a centrifugal force sufficient to stabilize the tools in the operating position.

This entails the need for a perfect balance of the rotor, which in any case is no longer obtained following inevitable deteriorations and wear of the tools, which furthermore occur with a dis-uniform distribution on all the tools, since they are stressed in different ways. Because of this, high levels of vibration are established, with a consequent increase in noisiness and wear on the supports of the rotary shaft.

As a result of the disposition of the tools in parallel rows, and in particular parallel to the axis of rotation of the rotary shaft, the tools of the same row simultaneously enter into contact with the material to be shredded, with the consequent onset of vibratory phenomena and sudden increases in the requirement of driving power in correspondence with such contacts.

It must also be added that, when the device and hence the rotary shaft stops, the tools, no longer supported by the centrifugal power, fall on themselves downwards, since they are subject only to the force of their own weight, knocking against the shaft and causing a corresponding and typical metallic noise. Furthermore, this situation is also repeated during start-up, until the centrifugal force becomes sufficient to support the tools.

Finally, the deflector plates present inside the external casing are generally welded to the casing and cannot therefore be removed. The deflector plates cannot therefore be replaced even after they have reached significant levels of wear, which occurs following the dynamic and turbulent action of the material to be shredded inside the cutting chamber. Consequently, it is inevitable over time that the deflector plates irreversibly lose their efficiency in guiding the material to be shredded inside the cutting chamber.

Technical aim of the present invention is to make available a shredder device, in particular for agricultural machines, which does not have the disadvantages cited above.

Within the framework of this technical aim, the main purpose of the invention is to propose a shredder device, in particular for agricultural machines, which maintains a correct disposition of the tools in any functioning condition of the device.

Another purpose of the invention is to propose a shredder device, in particular for agricultural machines, which reduces the need for balancing the rotary shaft and consequently the wear generated on the supports of the device.

Moreover, an important purpose of the invention is to propose a shredder device, in particular for agricultural machines, which reduces the vibratory phenomena started by the operation of the device.

It is also an important purpose of the invention to propose a shredder device, in particular for agricultural machines, that eliminates the annoying impacts of the tools on the rotary shaft, typical of every time the device stops and starts.

It is also an important purpose of the invention to propose a shredder device, in particular for agricultural machines, that allows to maintain over time a good efficiency in guiding the material to be shredded inside the cutting chamber.

These and other purposes are substantially achieved by a shredder device for agricultural machines according to the description given in one or more of the attached claims.

Further characteristics and advantages of the present invention will become apparent from the following detailed description of a preferential but non-restrictive form of embodiment of a shredder device, in particular for agricultural machines, according to the present invention. The description is given with reference to the attached drawings, which are also given purely as an example and therefore non-restrictive, wherein:

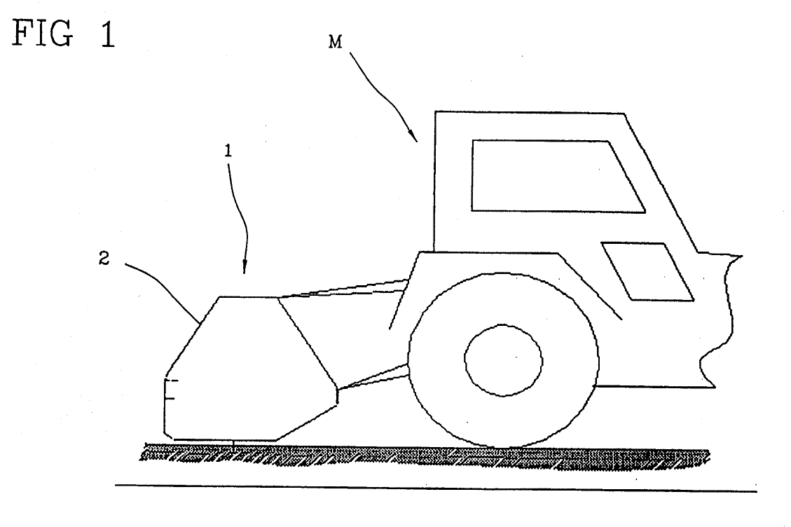

FIG. 1 shows a lateral view of a shredder device according to the invention in functioning conditions;

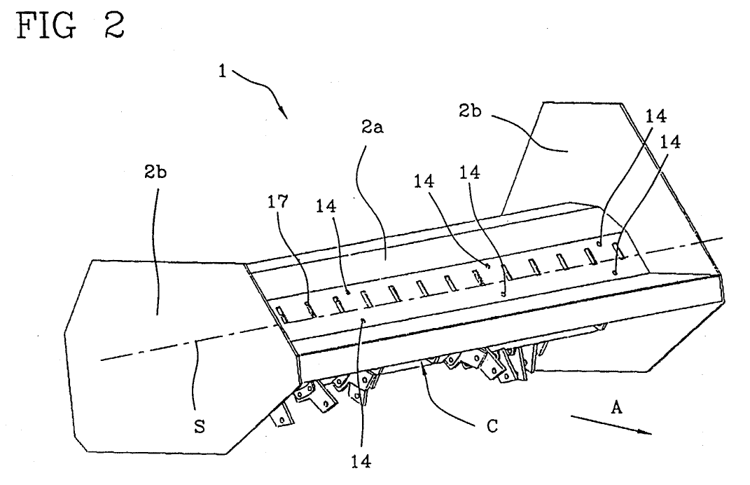

FIG. 2 shows a perspective view of the device in FIG. 1 with some parts removed so as to show others better;

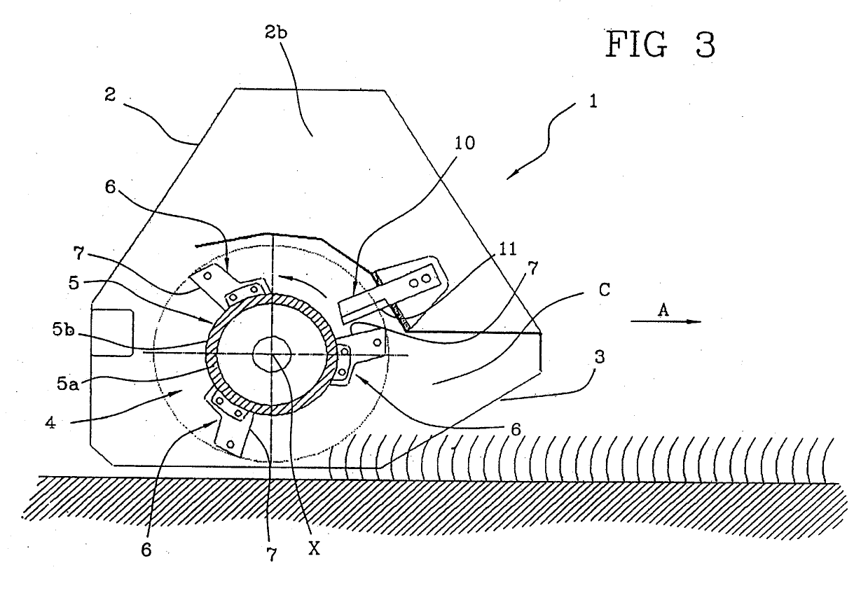

FIG. 3 shows a view in section of the device in FIG. 1 in operating conditions, according to a preferential form of embodiment;

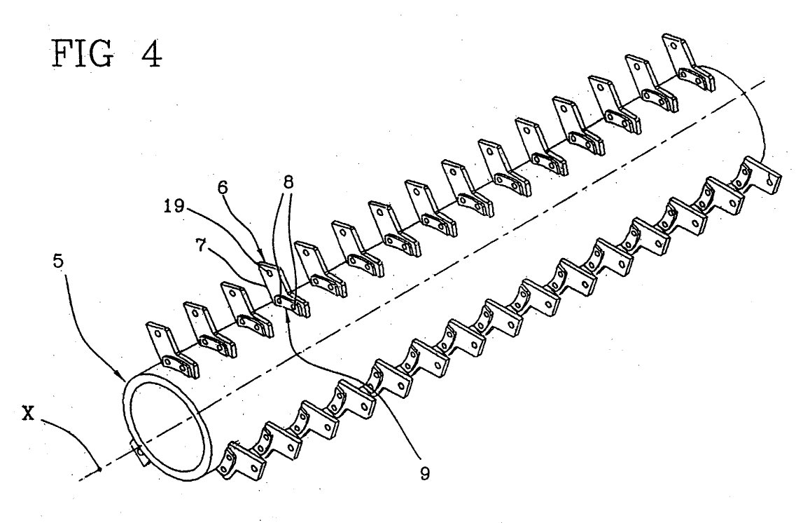

FIG. 4 is a perspective view of a component of the device in FIG. 1 according to a first form of embodiment;

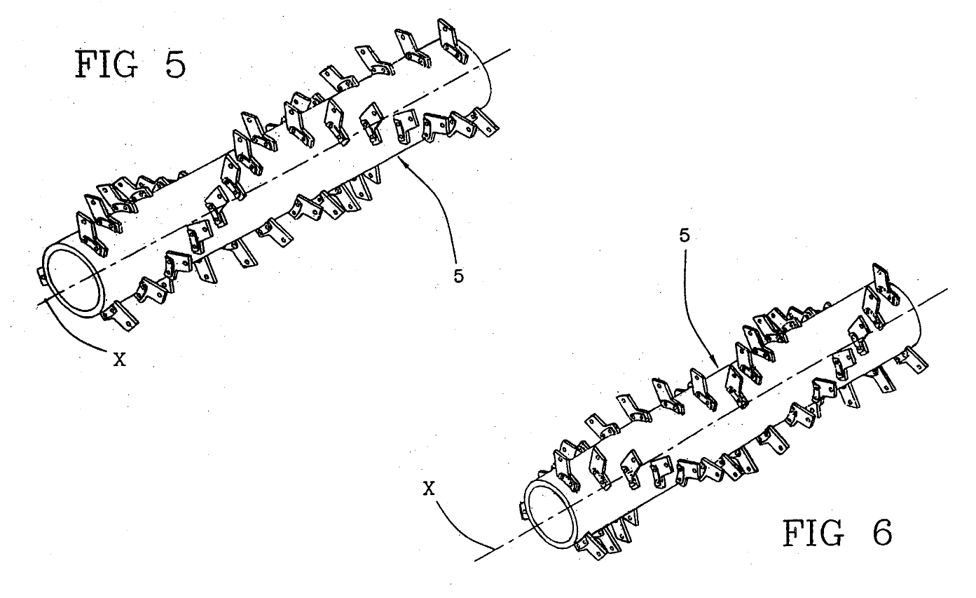

FIG. 5 shows a perspective view of the component in FIG. 4 according to a second form of embodiment;

FIG. 6 shows a perspective view of the component in FIG. 4 according to a third form of embodiment;

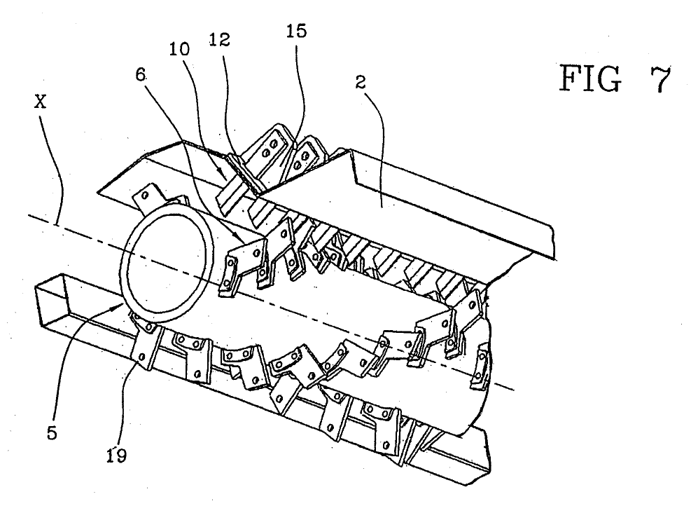

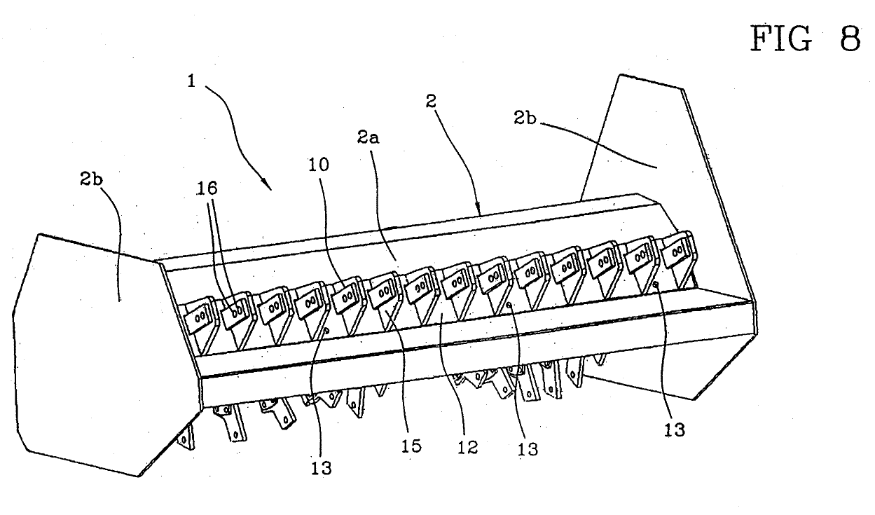

FIG. 7 shows a perspective view of the device in FIG. 3 with some parts removed to show others better;

FIG. 8 shows a perspective view of the device in FIG. 3;

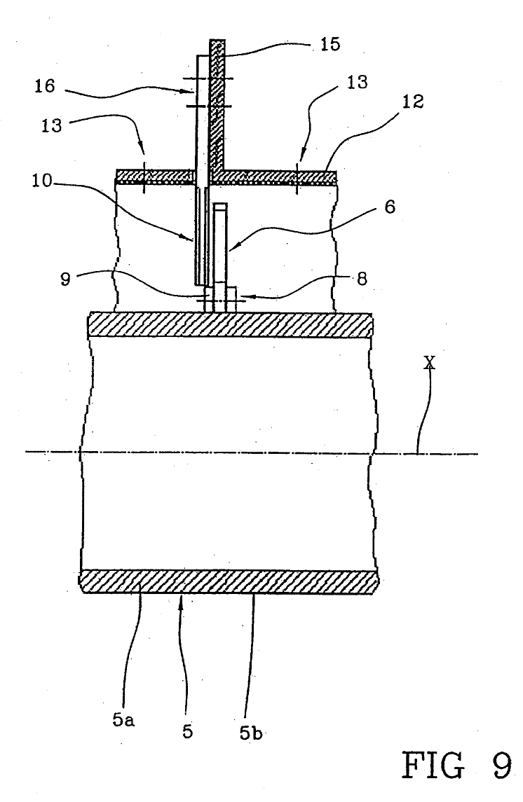

FIG. 9 shows a view in section of a part of the device in FIG. 3;

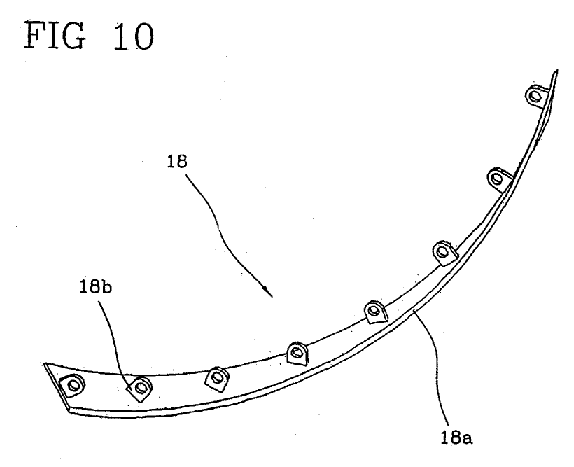

FIG. 10 shows a perspective view of the component in FIG. 1 according to a constructional variant;

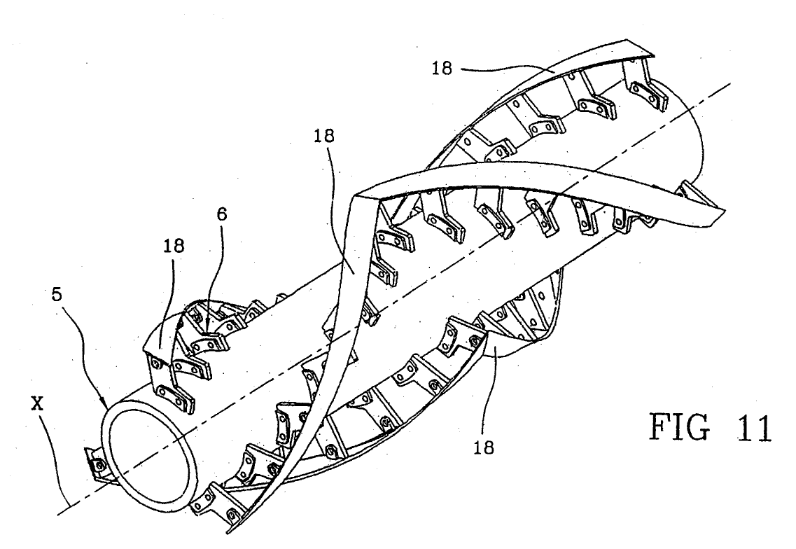

FIG. 11 shows a perspective view of the component in FIG. 10 in an operating configuration;

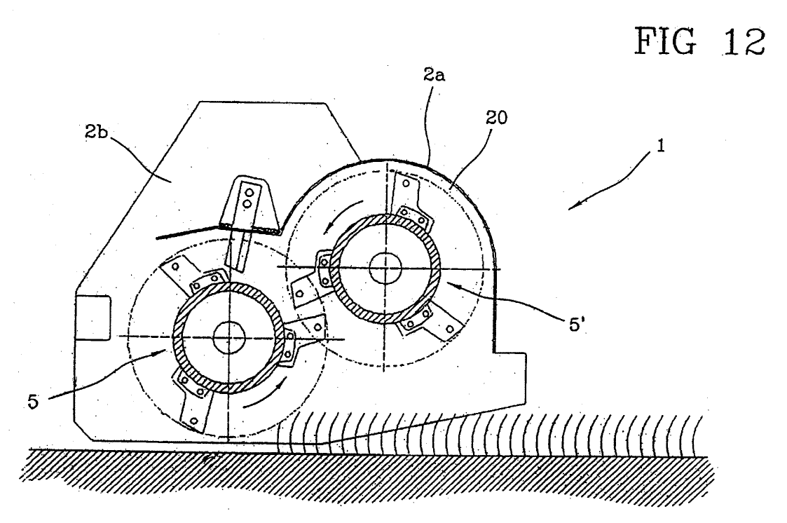

FIG. 12 shows a view in section of the device in FIG. 3 in operating conditions, according to a constructional variant;

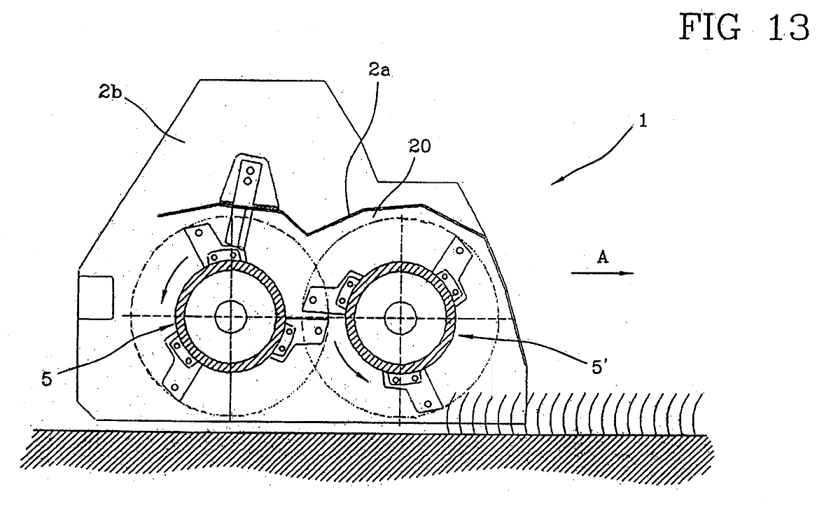

FIG. 13 shows a view in section of the device in FIG. 3 in operating conditions, according to another constructional variant.

With reference to the attached drawings, the number 1 denotes generally a shredder device according to the invention. The device 1 can be used by coupling it with an agricultural machine “M”, for example a tractor as shown in FIG. 1.

The device 1 is anchored to a rear portion of the agricultural machine “M” and receives the mechanical power necessary for it to function by means of transmission means (not shown), for example through a universal joint type coupling with a main transmission shaft of the agricultural machine “M”. The device 1 is also preferably equipped with an internal transmission, in particular a reducer or multiplier, to adopt the functioning of the device 1 to the number of revs of the main transmission shaft of the agricultural machine “M”.

The device 1 comprises a bearing structure 2, which has anchoring means of a known type, and therefore not shown here, to associate the device 1 stably to the agricultural machine “M”. The anchoring means constrains the device 1 to the agricultural machine “M” in rigid manner, since the device 1, during functioning, does not touch the ground but is raised, although only a little, brushing the profile of the ground.

The bearing structure 2, as shown in FIG. 2, has containing walls to delimit inside it, and in cooperation with the ground, a cutting chamber “C” inside which the process of shredding and cutting a material deposited on the ground occurs, in particular grass or woody material. The cutting chamber “C” must be suitably delimited with respect to the external environment to prevent part of the material being shredded from being accidentally projected outside and causing damage or injuries to operators present there.

In detail, in the preferential form of embodiment shown in FIG. 2, the bearing structure 2 of the device 1 comprises a metal sheet 2a laterally delimited by two opposite and parallel lateral plates 2b, rigidly connected to the metal sheet 2a. The metal sheet 2a has a main direction of development “S” perpendicular to a direction of advance “A” of the device 1 during its functioning, while the lateral plates 2b are disposed transverse to the metal sheet 2a and perform the function of bearing said metal sheet 2a.

Preferably, the metal sheet 2a comprises a portion shaped like a cap to define, in cooperation with the ground, said cutting chamber “C”. Moreover, the metal sheet 2a has a front aperture 3, more visible in FIG. 3, with respect to the direction of advance “A”. The front aperture 3 has the function of promoting the entrance of the material to be shredded inside the cutting chamber “C” during the advance of the device 1, defining a useful transit section for the material. The bearing structure 2 also has one or more rear apertures, not shown, through which the shredded material exits. The device 1 also comprises shredding means 4, mounted on the bearing structure 2 and housed inside the cutting chamber “C”. The shredding means 4 is movable so as to intercept and shred the material deposited on the ground and fed to the cutting chamber “C” through the front aperture 3.

The shredding means 4 is driven by said transmission means, which takes a part of the power delivered by the agricultural machine “M” and supplies it to the shredding means 4 in order to guarantee the functioning thereof.

In detail, the shredding means 4 comprises at least a rotor 5 rotatable around its longitudinal axis “X” and supporting a plurality of blades 6 for shredding the material.

In a first form of embodiment shown in FIGS. 1 to 11, the shredding means comprises a single rotor 5, whose axis of rotation “X” is parallel to the main direction of development of the metal sheet 2a. In this configuration, the rotor 5 is disposed perpendicularly to the direction of advance “A” during the functioning of the device 1.

As shown in FIG. 3, the rotor 5 is defined by a tubular element 5a, preferably cylindrical and with a circular section, supported laterally on said lateral plates 2b by means of supports of a known type, for example a pair of rolling bearings.

The blades 6 are mounted on an external surface 5b of the tubular element 5a. In particular, the blades 6 extend from said external surface 5b away from the axis of rotation “X” of the rotor 5.

Advantageously, each of said blades 6 is rigidly constrained to the rotor 5. In this way, each blade 6 assumes a stable position with respect to the rotor 5, and therefore keeps its position fixed with respect to the rotor 5, even during the rotation of the latter.

During the rotation of the rotor 5, therefore, each blade 6 is movable between a plurality of positions comprised between a first position, distant from the ground, in which it acts by shredding the material, and a second position, close to the ground, in which it intercepts the material to be shredded, deposited on the ground, and conveys it inside the cutting chamber “C”.

Each blade 6 has a cutting edge 7 for shredding the material inside the cutting chamber “C”. Preferably, the cutting edge 7 lies in a plane perpendicular to the axis of rotation “X” of the rotor 5 and develops in a direction perpendicular to said axis of rotation “X”. In this configuration, the cutting edge 7 therefore extends radially from the axis of rotation “X” of the rotor 5.

The blades 6 are removably constrained to the rotor 5, for example by means of first pairs of threaded connections 8, so as to allow to replace the blades 6 after wear on the respective cutting edges 7 or following breakage thereof. In particular, the rotor 5 is equipped with a plurality of brackets 9 solid with the rotor 5, each of which is able to be coupled with a respective blade 6 by means of said first pair of threaded connections 8.

Said blades 6 are disposed on the rotor 5 in rows reciprocally distanced along an angular development of the rotor 5. In accordance with a preferential form of embodiment, shown in the attached drawings, the blades 6 are disposed in three rows angularly equidistant by 120° with respect to each other, determining a symmetrical configuration.

Preferably, each of the rows extends along an entire length of the rotor 5 along the axis of rotation “X”, so as to increase the shredding efficiency of the device 1. Moreover, the rows can be rectilinear, preferably parallel to the axis of rotation “X” of the rotor 5 according to the form of embodiment shown in FIG. 4.

Alternatively, the rows are conformed helically, in particular in the form of a concave or convex arrow, according to the forms of embodiment shown in FIGS. 5 and 6. These last conformations are symmetrical with respect to a central portion of the rotor 5, and guarantee a more gradual shredding action with respect to the rectilinear rows parallel to the axis of rotation “X” of the rotor 5, due to the fact that the different blades 6 enter into progressive contact with the material to be shredded.

Advantageously, the shredding means 4 also comprises a plurality of counter-blades 10, operatively associated with the rotor 5 and attached rigidly and in a stable position to the bearing structure 2 of the device 1. Each counter-blade 10, during the rotation of the rotor 5, is active between two adjacent blades 6 of the same row, to achieve a relative movement between the counter-blade 10 and said two adjacent blades 6, in this way promoting the shredding action of the material. Advantageously, moreover, each counter-blade 10 has a respective cutting edge 11 cooperating with the cutting edge 7 of at least one of the respective pair of blades 6 with which it is associated. Preferably, the cutting edge 11 of each counter-blade 10 is operatively associated, during the rotation of the rotor 5, with the cutting edge 7 of respective blades 6 in succession. In particular, the cutting edge 11 of each counter-blade 10 intercepts the cutting edge 7 of respective blades 6 in succession in order to achieve, in cooperation with the blades 6, a scissor-like cutting action between the cutting edge 11 of the counter-blade 10 and the cutting edge 7 of a blade 6 during the rotation of the rotor 5. FIG. 9 shows a portion of the device sectioned along a plane passing through the axis of rotation “X” of the rotor 5. In this drawing it can be seen that the blade 6 and the counter-blade 10 associated therewith operate at a very close distance, almost grazing each other, thus producing said scissor-like action.

In one form of embodiment, not shown here, each blade 6 is operatively associated with a pair of counter-blades 10 opposite the blade 6 itself. In another form of embodiment, not shown here, each blade 6 is constrained to the rotor 5 rotatably around a respective axis parallel to the axis of rotation “X” of the rotor 5 and solid with the rotor 5. Each blade 6, which is rotatably constrained to the rotor 5 for example by means of a pin or screw, is supported in the operating position by the centrifugal force to which it is subjected following the rotation of the rotor 5. The blades are therefore able to rotate freely, with respect to the rotor, around the respective axes of rotation.

Advantageously, each blade 6 is operatively associated with a respective counter-blade 10 or with a respective pair of counter-blades 10, rigidly constrained to the bearing structure 2 and having the characteristics of the counter-blades 10 as previously described. The cooperation between the blades 6 and the counter-blades 10 achieves scissor-like cutting actions, in which each blade has a respective cutting edge 7 operatively associated with the cutting edge 11 of the respective counter-blade 10.

It must be added that, to generate the correct shredding action, the cutting edges 11 of the counter-blades 10 must be opposite the cutting edges 7 of the blades 6 according to a direction of advance of the blades 6 dictated by the rotation of the rotor 5. In this way, the material is comprised between the cutting edge 7 of one blade 6 and the cutting edge 11 of a counter-blade 10, with consequent optimum shredding of the material.

Moreover, the counter-blades 10 are disposed along one or more rows equidistant from each other with respect to the axis of rotation of the rotor 5. Preferably, the rows are parallel with each other. Advantageously, the rows are also parallel to the axis of rotation “X” of the rotor 5 so as to generate, when the blades 6 are disposed in helical rows, an action of gradual shredding of the material, connected to a progressive engagement of each row of blades 6 with a respective row of counter-blades 10, as shown in FIG. 7.

The counter-blades 10 are removably constrained to a base plate 12 shown in FIG. 8, which is removably attachable to the bearing structure 2 by means of removable connection means, for example screw connections 13, not shown, acting on holes 14 made on the bearing structure 2 and visible in FIG. 2. The base plate 12 has a plurality of reciprocally adjacent attachment plates 15, preferably parallel to the axis of rotation of the rotor 5, each of which able to be associated stably with a respective counter-blade 10, for example by means of a second pair of threaded connections 16.

With reference to the form of embodiment cited previously and not shown, each attachment plate 15 supports a pair of counter-blades 10 opposite and operatively associated with the same blade 6, so that during the rotation of the rotor 5 the blade 6 transits in a portion of space comprised between the cited pair of counter-blades 10.

To allow the coupling of the base plate 12, supporting the counter-blades 10, and the bearing structure 2, the latter has a plurality of through eyelets 17 having the same alignment as the counter-blades 10. In this way, by bring the base plate 12 adjacent to the bearing structure 12, the counter-blades 10 are inserted inside the respective eyelets 17, reaching respective positions inside the cutting chamber “C”.

A peculiar characteristic of the device 1 according to the invention is the possibility of assembling a vast series of cutting accessories without requiring the dis-assembly of the blades 6. In particular, a particularly advantageous form of embodiment is obtained by assembling on the rotor 5 a mowing blade 18, in particular for cutting grass, shown individually and in detail in FIG. 10.

The mowing blade 18 has a predominant direction of development and can be engaged directly with the blades 6 of the same row by means of a removable connection. In detail, the mowing blade 18 has a front cutting edge 18a, which extends preferably along the entire length of the blade 18. Moreover, the blade 18 is equipped with a plurality of attachments 18b distributed along the blade 18, for example holed eyelets, and able to engage with respective blades 6 of the same row. Preferably, each blade 6 has a respective seating 19 in correspondence with its own end farthest from the axis of rotation “X” of the rotor 5. The seating is able to engage removably with a respective attachment 18b of said blade, for example by means of a threaded coupling, not shown.

The mowing blade 18 also has a curved conformation, in particular twisted, in order to adapt to a helical conformation of each row of blades 6, as shown in FIGS. 10 and 11. Moreover, the blade 18 can consist of two or more sectional modules which, assembled in sequence on the same row of blades 6, define a continuous cutting front for an entire length of the rotor 5 along the axis of rotation “X” of the rotor 5.

In the event that the mowing blade 18 is assembled, it is necessary to remove the counter-blades 10 which would interfere functionally with the rotation of the rotor 5. The removal of the counter-blades 10 is also easy, simply requiring to dismantle and remove the base plate 12 alone.

Advantageously, the shredding means 4 comprises movable counter-blades, to intensify the shredding action of the material. The movable counter-blades preferably engage with the blades of the rotor 5 and are operatively associated with the latter in accordance with a functioning principle similar to the one previously described.

According to another form of embodiment which will now be described, the shredding means 4 comprises two rotors 5, 5′, each of which has the characteristics previously described in the form of embodiment of the device 1 having a single rotor 5. In this configuration, the movable counter-blades consist of the blades 6 of one of the rotors 5, 5′, which blades 6 rotate around the axis of rotation “X” of the respective rotor 5, 5′ and engage with the blades 6 of the other rotor 5, 5′ in the same way as we saw that the fixed counter-blades 10 engaged with the blades 6 of the rotor 5.

FIG. 12 shows a view in section of a device 1 having the characteristics just listed. The two rotors 5, 5′ are located inside the cutting chamber “C” and are parallel with each other, in particular they rotate around respective axes of rotation “X” parallel with each other. The two rotors 5, 5′ are also operatively associated with each other in order to intercept and shred the material, in particular in correspondence with a portion of the cutting chamber “C” comprised between the two rotors 5, 5′.

So that the two rotors 5, 5′ in cooperation generate an effective scissor-type shredding action, the rotors 5, 5′ rotate in the same direction and the dispositions of the blades 6 on the respective rotors 5, 5′ are corresponding, so that the blades 6 of the two different rotors 5, reciprocally engage in succession, determining the aforesaid scissor-type shredding action.

To obtain this, preventing interference in the interaction between the blades 6, the distribution of the blades 6 on the two different rotors 5, 5′ must be offset, along the axes of rotation “X”, by a quantity necessary so that the engagement between each pair of blades 6 occurs without reciprocal impacts or friction, and in any case keeping a limited distance between the two blades 6 as measured along the axes of rotation “X”.

Moreover, each blade 6 of each rotor 5, 5′ must have a cutting edge 7 directed in the same direction as the corresponding blade 6 of the other rotor 5, 5′, so that in the zone of interaction between the two rotors 5, 5′ the cutting edges 7 of each pair of blades 6 in reciprocal engagement are opposite each other and therefore generate a scissor-type action on the material to be shredded. It is also possible to provide that at least one of the two rotors 5, 5′ is operatively associated with a group of fixed counter-blades 10 operating in a totally analogous manner as seen in the form of embodiment of the device 1 having a single rotor 5, 5′, so as to contribute effectively to the shredding action actuated on the material.

According to a form of embodiment shown in FIG. 12, a first rotor 5 is located in a position brushing the ground and preferably in a retracted position with respect to the direction of advance “A” of the device 1. The other rotor 5′ on the contrary is located in a raised position, advanced with respect to the first rotor 5, so as to allow the material present on the ground to be fed into the cutting chamber “C” through the front aperture 3 and to reach the first rotor 5. From here the material is thrust by the blades of the first rotor 5 until it reaches a zone comprised between the two rotors 5, 5′ and is subjected to the shredding action. To achieve this function the first rotor 5 rotates in the direction indicated by the respective arrow in FIG. 12, and in particular rotates in the opposite direction with respect to a natural rolling rotation which would tend to submit consequently to the advance of the device. In other words, the rotor 5 that rotates close to the ground moves the blades 6 nearest the ground in a direction equal to the direction of advance “A” of the device 1, generating an action of scraping the material which tends to be lifted from the ground.

Part of the material that reaches the cutting chamber “C” is also drawn in rotation by the second rotor 5′ in an interspace 20 delimited by the second rotor 5′ itself and by the metal sheet 2a, then drawn towards said zone comprised between the two rotors 5, 5′ and then subjected to shredding.

As shown in FIG. 12, the metal sheet 2a is conformed, in section, as a dove-tail, in order to follow the peripheral developments of the two rotors 5, 5′ and hence to convey the material towards the zone comprised between the two rotors 5, 5′, forcing the material to enter into contact with the blades 6 and receive from them an effective shredding action.

According to another form of embodiment shown in FIG. 13, the two rotors 5, 5′ are both located in a position close to the ground. One of the two rotors 5, 5′ located in an advanced position with respect to the direction of advance “A” of the device 1, enters into contact first with the material to be shredded fed in through the front aperture 3. The material is then drawn into rotation inside said interspace 20 and then conveyed, in cooperation with the dove-tailed shape of the metal sheet 2a, towards the zone comprised between the two rotors 5, 5′, in which it is subjected to the shredding process. Any possible parts of material that might not be intercepted by the first of the two rotors 5, 5′ would be taken up by the second of the rotors 5, 5′ and thrust, through the movement of the respective blades 6, towards the zone comprised between the two rotors 5, 5′.

The rotation of the two rotors 5, 5′, which as we saw proceeded in the same direction, is for example achieved by means of a mechanical kinematism between the two rotors 5, 5′, which also has the task of imposing on the two rotors 5, 5′ the same speed of rotation. The kinematism is of a known type and therefore has not been shown in the drawings.

The present invention achieves the purposes set.

First of all, the fact that the blades are attached to the rotor, and the absence of any degrees of freedom of the blades with respect to said rotor guarantee a correct disposition of the cutting edges in every functioning condition, preventing the blades from modifying their position with respect to the rotor, for example in conditions when the cutting chamber is very full.

Moreover, this allows to reduce the speed of rotation of the rotor with respect to shredder devices of a known type, since it eliminates the need for the action to stabilize the centrifugal force on the blades. Consequently, we have a more regular functioning of the device, with fewer vibrations set off and less wear, and also a lesser need to balance the rotor and a reduced noisiness in functioning. To this must be added a greater economy in production and maintenance.

Furthermore, the reduced speed of rotation of the rotor allows to increase the intrinsic safety of the device, which decreases as the speed of rotation of the rotor increases. Moreover, as a result, the shredded material is expelled with a reduced kinetic energy, with fewer risks that the material might be pressed violently down into the ground, and hence buried therein.

Furthermore, the stable positioning of the blades with respect to the rotor eliminates the annoying contacts between the blades and the rotor, which is characteristic of known devices.

Another important advantage of the shredder device according to the invention is the efficiency of the shredding process, which takes place by closing the blades on the counter-blades. This achieves a cutting action that is considerably better than devices in the state of the art, since the cutting is no longer entrusted to the thrust of the cutting edge on the material to be shredded, but to the scissor-like action generated by the interaction between the cutting edge and counter edge.

This also allows to increase the time the device can be used, since the functioning is less affected by the sharpness of the cutting edges and hence less susceptible to wear thereon.

Furthermore, another advantage of the shredder device according to the invention is connected to the helical distribution of the blades on the rotor, which generates a gradual contact of the blades with the material to be shredded and hence a more regular functioning. This also reduces the instantaneous shredding force and hence the instantaneous power absorbed by the device.

Finally, an important advantage is given by the possibility of assembling different accessories, such as the mowing blade, without needing to remove the blades but using them as a support for the mowing blade itself.

1. A shredder device for agricultural machines, comprising:
a bearing structure, able to be stably associated with a drive machine (M) and defining, in cooperation with the ground, a cutting chamber;
at least one rotor rotatable around an axis of rotation, assembled on said bearing structure and housed inside said cutting chamber; and
a plurality of blades, supported on said at least one rotor and extending away from the axis of rotation of said at least one rotor in order to intercept and shred material deposited on the ground,
wherein each of said plurality of blades is substantially rigidly constrained and in a stable position on said rotor.

2. The shredder device as in claim 1, further comprises further comprising a motion transmission means connected to said drive machine, to receive from said drive machine the power to make said at least one rotor rotate.

3. The shredder device as in claim 1, wherein during the rotation of said at least one rotor, said plurality of blades assume a plurality of operating positions comprised between a first position more distant from the ground, in which said plurality of blades act by shredding the material, and a second position close to the ground, in which said plurality of blades intercept the material to be shredded and convey said material inside said cutting chamber.

4. The shredder device as in claim 1, wherein each one of said plurality of blades has at least one cutting edge lying in the direction of rotation of said at least one rotor.

5. The shredder device as in claim 4, wherein said at least one cutting edge extends radially with respect to the axis of rotation of said at least one rotor.

6. The shredder device as in claim 1, wherein said plurality of blades are removably attached to said at least one rotor, to allow said plurality of blades to be replaced following determinate levels of wear.

7. The shredder device as in claim 1, wherein said plurality of blades are disposed in reciprocally equidistant rows along an angular development of said at least one rotor.

8. The shredder device as in claim 7, wherein said rows are disposed along a helical conformation or in line.

9. The shredder device as in claim 8, wherein said helical conformation defines a helix conformed as a convex or concave arrow.

10. The shredder device as in claim 1, further comprising a plurality of counter-blades operatively associated with said at least one rotor, said plurality of counter-blades being substantially rigidly attached and in a stable position on said bearing structure and active, during the rotation of said at least one rotor, between at least one adjacent blade of said plurality of blades in order to achieve a relative movement between at least one of said plurality of counter-blades and said adjacent blade of said plurality of blades, facilitating the shredding of the material.

11. The shredder device as in claim 10, wherein each of said plurality of counter-blades has a respective cutting edge in a position opposite said cutting edge of said plurality of blades with respect to a direction of advance of said plurality of blades, in order to intercept said cutting edges of said respective plurality of blades in succession, and to achieve, in cooperation with said plurality of blades, a relative scissor-like movement between said cutting edge of said plurality of counter blade counter-blades and said cutting edge of said respective plurality of blades when said at least one rotor is moving.

12. The shredder device as in claim 10, wherein said plurality of counter-blades are disposed along one or more rows parallel to the axis of rotation of said at least one rotor.

13. The shredder device as in claim 10, wherein said plurality of counter-blades are removably constrained to said bearing structure, to allow said plurality of counter-blades to be replaced following predetermined levels of wear.

14. The shredder device as in claim 13, wherein said plurality of counter-blades are attached on respective attachment plates extending from said bearing structure in a direction transverse to the axis of rotation of said at least one rotor.

15. The shredder device as in claim 7, wherein at least one of said rows of said plurality of blades stably supports a mowing blade, said mowing blade being conformed with the respective row of said plurality of blades with which said mowing blade is associated.

16. The shredder device as in claim 15, wherein said mowing blade has a plurality of attachments, each able to engage with an end portion of a respective one of said plurality of blades.

17. The shredder device as in claim 16, wherein each of said plurality of attachments comprises a holed eyelet, able to engage removably with a corresponding seating made on the respective one of said plurality of blades (6).

18. The shredder device as in claim 15, wherein said mowing blade comprises two or more sectional modules assembled in sequence on the same row of said plurality of blades for defining a continuous cutting front for an entire length of said rotor at least one along the respective axis of rotation.

19. The shredder device as in claim 1, wherein said at least one rotor comprises two rotors each rotatable around respective parallel axes and operatively associated so as to intercept and shred said material, said plurality of blades of said two rotors having corresponding distributions on the two rotors to reciprocally engage in succession, defining scissor-like cutting actions on the material intercepted, said distributions being reciprocally offset along an axis of rotation of said two rotors to allow said cutting action.

20. The shredder device as in claim 4, wherein said plurality of blades of each of said two rotors each has a respective cutting edge directed in the same direction as the cutting edge of corresponding plurality of blades of the other rotor, said two rotors being able to be driven in rotation in the same direction so as to achieve said scissor-like cutting action.

21. The shredder device as in claim 1, wherein a first rotor of said two rotors rotates in a position brushing the ground, so as to intercept the material to be shredded, whereas a second rotor of said two rotors is located in a raised position with respect to the ground so as to exert an effective shredding action in cooperation with said first rotor and facilitate the feed of said material to said first rotor.

22. The shredder device as in claim 19, wherein said two rotors are connected with each other by means of a mechanical kinematism, so as to impart to said two rotors the same speed of rotation.

23. The shredder device as in claim 1, wherein said at least one rotor rotates in a direction such as to move the respective plurality of blades nearest the ground in a direction equal to a direction of advance of the device with respect to the ground.

24. An agricultural shredding machine, comprising a shredder device according to claim 1.

25. A shredder device, for agricultural machines, comprising:
a bearing structure, able to be stably associated with a drive machine and defining, in cooperation with the ground, a cutting chamber;
at least a one rotor rotatable around an axis of rotation, assembled on said bearing structure and housed inside said cutting chamber;
a plurality of blades, supported on said at least one rotor and rotatable, with respect to said at least one rotor, around respective axes of rotation in order to intercept and shred material deposited on the ground, said axes of rotation of the plurality of blades being parallel to the axis of rotation of said at least one rotor,
wherein each of said plurality of blades is operatively associated with a respective counter-blade rigidly constrained to said bearing structure, each one of said plurality of blades being in cooperation with a respective counter-blade for defining, following the rotation of said at least one rotor, a scissor-like cutting action on the material to be shredded.
